(19) United States
(12) Patent Application Publication
(10) Pub. No.: US 2026/0039433 A1
(43) Pub. Date: Feb. 5, 2026

(54) METHODS AND APPARATUS TO SUPPORT MORE DMRS PORTS FOR CP-OFDM WAVEFORM

(71) Applicant: APPLE INC., Cupertino, CA (US)

(72) Inventors: Haitong Sun, Cupertino, CA (US); Dawei Zhang, Saratoga, CA (US); Wei Zeng, San Diego, CA (US); Chunxuan Ye, San Diego, CA (US); Seyed Ali Akbar Fakoorian, San Diego, CA (US); Ankit Bhamri, Bad Nauheim (DE)

(21) Appl. No.: 18/998,777

(22) PCT Filed: Aug. 10, 2022
(86) PCT No.: PCT/US2022/074739

§ 371 Date: Jan. 27, 2025

(51) Int. Cl. H04L 5/00; H04W 72/231; H04W 76/20; H04W 80/02

(52) U.S. Cl. CPC H04L 5/0051; H04L 5/001; H04W 72/231; H04W 76/20; H04W 80/02

(57) ABSTRACT

Apparatus and methods are provided for communication in a wireless network. A communication device processes a radio resource control (RRC) message from the wireless network including demodulation reference signal (DMRS) configuration information with at least one of a DMRS configuration type, a maximum number of DMRS symbols per location, a DMRS starting position, and a DMRS additional position. The communication device processes a dynamic DMRS mode indication from the wireless network for the communication device to select one of a first DMRS mode that supports up to 12 DMRS ports and a second DMRS mode that supports up to 24 DMRS ports. The communication device processes a DMRS based on a selection of the first DMRS mode or the second DMRS mode indicated by the dynamic DMRS mode indication from the wireless network.

### TECHNICAL FIELD

This application relates generally to wireless communication systems, including systems using cyclic prefix orthogonal frequency division multiplexing (CP-OFDM) waveforms.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates physical resource blocks (PRBs) with demodulation reference signal (DMRS) configuration type 1 and DMRS configuration type 2.

FIG. 2A and FIG. 2B illustrate example DMRS port mappings.

FIG. 3 is a flowchart of a method for a base station in a wireless network to configure multi-user multiple-input multiple-output (MU-MIMO) scheduling according to one embodiment.

FIG. 4 illustrates an example data structure of a media access control (MAC) control element (CE) for indicating a DMRS mode to a UE according to one embodiment.

FIG. 5 is a flowchart of a method for a UE in a wireless network according to one embodiment

FIG. 6 is a method for a base station in a wireless network according to one embodiment.

FIG. 7 illustrates an example architecture of a wireless communication system, according to embodiments disclosed herein.

FIG. 8 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

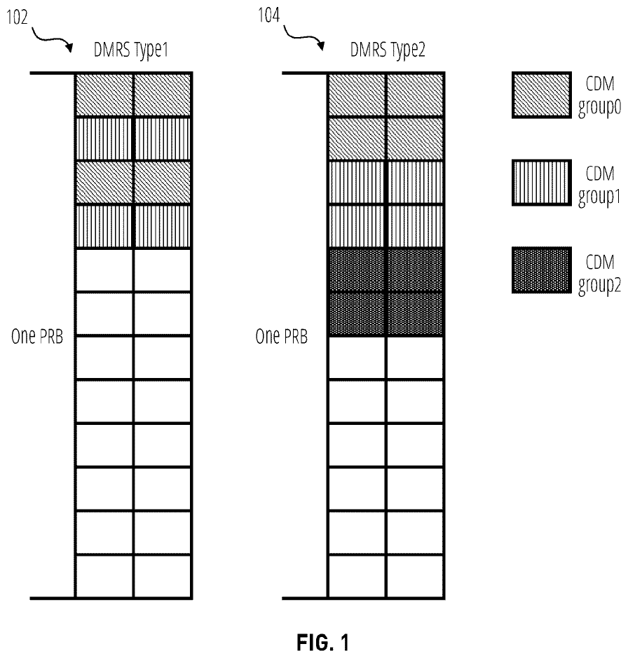

For CP-OFDM waveforms, certain NR systems support two demodulation reference signal (DMRS) configuration types for both downlink (DL) and uplink (UL). For example, FIG. 1 illustrates physical resource blocks (PRBs) with DMRS configuration type 1 (also referred to herein as DMRS Type1) and DMRS configuration type 2 (also referred to herein as DMRS Type2).

DMRS configuration type 1 supports up to four ports for a single symbol DMRS and up to eight ports for a two symbol DMRS. As shown for PRB 102, DMRS Type1 may use two DMRS code division multiplexing (CDM) groups (shown as CDM group0 and CDM group1).

DMRS configuration type 2 supports up to six ports for a single symbol DMRS and up to 12 ports for a two symbol DMRS. As shown for PRB 104, DMRS Type2 may use three DMRS CDM groups (CDM group0, CDM group1, and CDM group2). Each DMRS CDM group repeats in the frequency domain using next entries in the DMRS sequence.

For DMRS Type1 and DMRS Type2, each CDM group uses two resource elements (REs) in the frequency domain and two symbols in the time domain. Each CDM group supports up to two ports for a single symbol DMRS and up to four ports for double symbol DMRS. A frequency domain orthogonal cover code (FD-OCC) of 2 (e.g., +1, −1) is used for the frequency domain and a time domain orthogonal cover code (TD-OCC) of 2 (e.g., +1, −1) is used for the time domain.

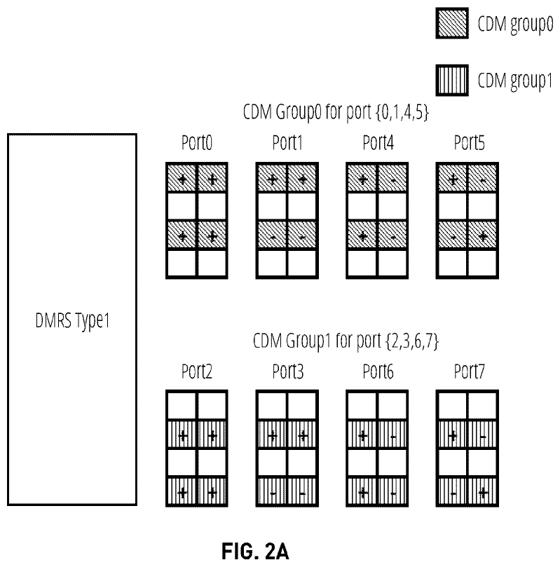

For example, FIG. 2A and FIG. 2B illustrate example DMRS port mapping for CP-OFDM with OCC shown as “+” and “−”. In a frequency selective fading channel (e.g., with large channel delay spread), ports separated by a cyclic shift may not be orthogonal at the receiver. Thus, there may be some cross-port interference. However, to avoid interference, OCC may be used to provide port separation. DMRS for different antenna ports may be distinguished using different (e.g., masking each signal with a different combination of +1 or −1 in different resource elements). In some cases, two sets of DMRS may be transmitted in adjoining resource elements.

DMRS may be transmitted according to a predefined pattern. In FIG. 2A, DMRS port mapping is shown for DMRS Type1. In particular, DMRS port mapping is shown for CDM group0 corresponding to a DMRS port 0, a DMRS port 1, a DMRS port 4, and a DMRS port 5 (DMRS port {0, 1, 4, 5}). DMRS port mapping is also shown for CDM group1 corresponding to a DMRS port 2, a DMRS port 3, a DMRS port 6, and a DMRS port 7 (DMRS port {2, 3, 6, 7}).

In FIG. 2B, DMRS port mapping is shown for DMRS Type2. In particular, DMRS port mapping is shown for CDM group0 corresponding to a DMRS port 0, a DMRS port 1, a DMRS port 6, and a DMRS port 7 (DMRS port {0, 1, 6, 7}). DMRS port mapping is also shown for CDM group1 corresponding to a DMRS port 2, a DMRS port 3, a DMRS port 8, and a DMRS port 9 (DMRS port {2, 3, 8, 9}). DMRS port mapping is also shown for CDM group2 corresponding to a DMRS port 4, a DMRS port 5, a DMRS port 10, and a DMRS port 11 (DMRS port {4, 5, 10, 11}).

In certain wireless systems (e.g., NR systems). DMRS enhancement may support a double amount of DMRS ports for CP-OFDM. For example, up to 12 orthogonal DMRS ports may be supported for DMRS Type1 and 24 orthogonal DMRS ports may be supported for DMRS Type2, wherein the maximum number of orthogonal ports is doubled for both single symbol and double symbol DMRS. To reduce the amount of DMRS overhead increase, or to avoid increasing the DMRS overhead, while doubling the amount of DMRS ports, certain embodiments disclosed herein provide one or more of multi-user multiple-input multiple-output (MU-MIMO) scheduling restrictions for DMRS Type1, MU-MIMO scheduling restrictions for DMRS Type2, and/or dynamic DMRS mode indication.

### MU-MIMO Schedule Restrictions for DMRS Type 1

For DL physical downlink shared channel (PDSCH), the DMRS port indication is indicated by an “antenna port(s)” field in downlink control information (DCI). For example. 3GPP Technical Specification (TS) 38.212 DMRS configuration Type 1 uses Tables 7.3.1.2.2-1/1A/2/2A, and DMRS configuration Type 2 uses Tables 7.3.1.2.2-3/3A/4/4A.

In certain wireless network, MU-MIMO co-scheduling is implicitly indicated by a “number of DMRS CDM group(s) without data” column from the “antenna port(s)” field in DCI. A benefit of supporting an increased number of DMRS ports, as provided by embodiments disclosed herein, is to provide the wireless network with more MU-MIMO scheduling flexibility.

Increasing the number of DMRS ports within a DMRS group may increase interference between different users in MU-MIMO. Thus, in one embodiment for DMRS Type1, when a new DMRS pattern is configured to support the increased number of DMRS ports, one or multiple of the following restrictions are used for MU-MIMO scheduling: the UE that uses the new DMRS pattern (supporting more DMRS ports) cannot be co-scheduled with the other UE that uses the new DMRS pattern in the same CDM group; and/or the UE that uses the new DMRS pattern (supporting more DMRS ports) cannot be co-scheduled with the other legacy UE that uses the legacy DMRS pattern (supporting fewer DMRS ports) in the same CDM group.

In one embodiment, when a new DMRS pattern is configured to support the increased number of DMRS ports, for DMRS configuration Type 1, if the wireless network indicates one CDM group without data, one symbol DMRS, and DMRS port {0, 1}, then one or multiple of the following restrictions for MU-MIMO scheduling are possible: the UE is not expected to be co-scheduled with any other UEs (e.g., this applies to the case when the number of CDM groups is increased to support the increased number of DMRS ports); and/or the UE can be co-scheduled with other UEs (e.g., this applies to the case when the number of CDM groups is not increased to support increased number of DMRS ports). When the UE can be co-scheduled with other UEs, in one embodiment, the co-scheduled UE is configured with the new DMRS pattern (supporting more DMRS ports). When the UE can be co-scheduled with other UEs, in another embodiment, the co-scheduled UE can be configured with either the new DMRS pattern (supporting more DMRS ports) or the legacy DMRS pattern (supporting fewer DMRS ports).

In one embodiment, when a new DMRS pattern is configured to support the increased number of DMRS ports, for DMRS configuration Type 1, if the wireless network indicates two CDM group without data, one symbol DMRS, and DMRS port {0, 1, 2, 3}, then one or multiple of the following restrictions for MU-MIMO scheduling are possible: the UE is not expected to be co-scheduled with any other UEs (e.g., this applies to the case when the number of CDM groups is increased to support increased number of DMRS ports); and/or the UE can be co-scheduled with other UEs (e.g., this applies to the case when the number of CDM groups is not increased to support increased number of DMRS ports). When the UE can be co-scheduled with other UEs, in one embodiment, the co-scheduled UE is configured with the new DMRS pattern (supporting more DMRS ports). When the UE can be co-scheduled with other UEs, in another embodiment, the co-scheduled UE can be configured with either the new DMRS pattern (supporting more DMRS ports) or the legacy DMRS pattern (supporting fewer DMRS ports).

In one embodiment, when a new DMRS pattern is configured to support the increased number of DMRS ports, for DMRS configuration Type 1, if the wireless network indicates two CDM groups without data, one symbol DMRS, and DMRS port {0, 2}, then one or multiple of the following restrictions for MU-MIMO scheduling are possible: the UE is not expected to be co-scheduled with any other UEs (e.g., MU-MIMO co-scheduling can be enabled instead by DMRS port {0, 1}); and/or the UE can be co-scheduled with other UEs. When the UE can be co-scheduled with other UEs, in one embodiment, the co-scheduled UE is configured with the new DMRS pattern (supporting more DMRS ports). When the UE can be co-scheduled with other UEs, in another embodiment, the co-scheduled UE can be configured with either the new DMRS pattern (supporting more DMRS ports) or the legacy DMRS pattern (supporting fewer DMRS ports).

In one embodiment, when a new DMRS pattern is configured to support the increased number of DMRS ports, for DMRS configuration Type 1, if the wireless network indicates two CDM groups without data, two symbol DMRS, and DMRS port {0, 2, 4, 6}, then one or multiple of the following restrictions for MU-MIMO scheduling are possible: the UE is not expected to be co-scheduled with any other UEs (e.g., MU-MIMO co-scheduling can instead be enabled by DMRS port {0,1,4,5}); and/or the UE can be co-scheduled with other UEs. When the UE can be co-scheduled with other UEs, in one embodiment, the co-scheduled UE is configured with the new DMRS pattern (supporting more DMRS ports). When the UE can be co-scheduled with other UEs, in another embodiment, the co-scheduled UE can be configured with either the new DMRS pattern (supporting more DMRS ports) or the legacy DMRS pattern (supporting fewer DMRS ports).

In one embodiment, when a new DMRS pattern is configured to support the increased number of DMRS ports, for DMRS configuration Type 1, if the wireless network indicates two CDM groups without data, one symbol DMRS, and DMRS port {0,1,2}, then one or multiple of the following restrictions for MU-MIMO scheduling are possible: the UE can be co-scheduled with other UEs; and/or the UE is not expected to be co-scheduled with any other UEs (e.g., DMRS configuration Type 2 can instead be used for MU-MIMO co-scheduling). When the UE can be co-scheduled with other UEs, in one embodiment, the co-scheduled UE is configured with the new DMRS pattern (supporting more DMRS ports). When the UE can be co-scheduled with other UEs, in another embodiment, the co-scheduled UE can be configured with either the new DMRS pattern (supporting more DMRS ports) or the legacy DMRS pattern (supporting fewer DMRS ports).

### MU-MIMO Schedule Restrictions for DMRS Type 2

In one embodiment, when a new DMRS pattern is configured to support the increased number of DMRS ports, for DMRS configuration Type 2, if the wireless network indicates one CDM group without data, one symbol DMRS, and DMRS port {0, 1}, then one or multiple of the following restrictions for MU-MIMO scheduling are possible: the UE is not expected to be co-scheduled with any other UEs (e.g., this applies to the case when the number of CDM groups is increased to support the increased number of DMRS ports); and/or the UE can be co-scheduled with other UEs (e.g., this applies to the case when the number of CDM groups is not increased to support increased number of DMRS ports). When the UE can be co-scheduled with other UEs, in one embodiment, the co-scheduled UE is configured with the new DMRS pattern (supporting more DMRS ports). When the UE can be co-scheduled with other UEs, in another embodiment, the co-scheduled UE can be configured with either the new DMRS pattern (supporting more DMRS ports) or the legacy DMRS pattern (supporting fewer DMRS ports).

In one embodiment, when a new DMRS pattern is configured to support the increased number of DMRS ports, for DMRS configuration Type 2, if the wireless network indicates two CDM groups without data, one symbol DMRS, and DMRS port {0, 1, 2, 3}, then one or multiple of the following restrictions for MU-MIMO scheduling are possible: the UE is not expected to be co-scheduled with any other UEs (e.g., this applies to the case when the number of CDM groups is increased to support the increased number of DMRS ports); and/or the UE can be co-scheduled with other UEs (e.g., this applies to the case when the number of CDM groups is not increased to support increased number of DMRS ports). When the UE can be co-scheduled with other UEs, in one embodiment, the co-scheduled UE is configured with the new DMRS pattern (supporting more DMRS ports). When the UE can be co-scheduled with other UEs, in another embodiment, the co-scheduled UE can be configured with either the new DMRS pattern (supporting more DMRS ports) or the legacy DMRS pattern (supporting fewer DMRS ports).

In one embodiment, when a new DMRS pattern is configured to support the increased number of DMRS ports, for DMRS configuration Type 2, if the wireless network indicates two CDM groups without data, one symbol DMRS, and DMRS port {0, 2}, then one or multiple of the following restrictions for MU-MIMO scheduling are possible: the UE is not expected to be co-scheduled with any other UEs (e.g., MU-MIMO co-scheduling can be enabled by DMRS port {0, 1}); and/or the UE can be co-scheduled with other UEs. When the UE can be co-scheduled with other UEs, in one embodiment, the co-scheduled UE is configured with the new DMRS pattern (supporting more DMRS ports). When the UE can be co-scheduled with other UEs, in another embodiment, the co-scheduled UE can be configured with either the new DMRS pattern (supporting more DMRS ports) or the legacy DMRS pattern (supporting fewer DMRS ports).

In one embodiment, when a new DMRS pattern is configured to support the increased number of DMRS ports, regardless of being for DMRS configuration Type 1 or DMRS configuration Type 2, if the wireless network indicates DMRS ports {0, 2, 3}, the UE is not expected to be co-scheduled with any other UEs.

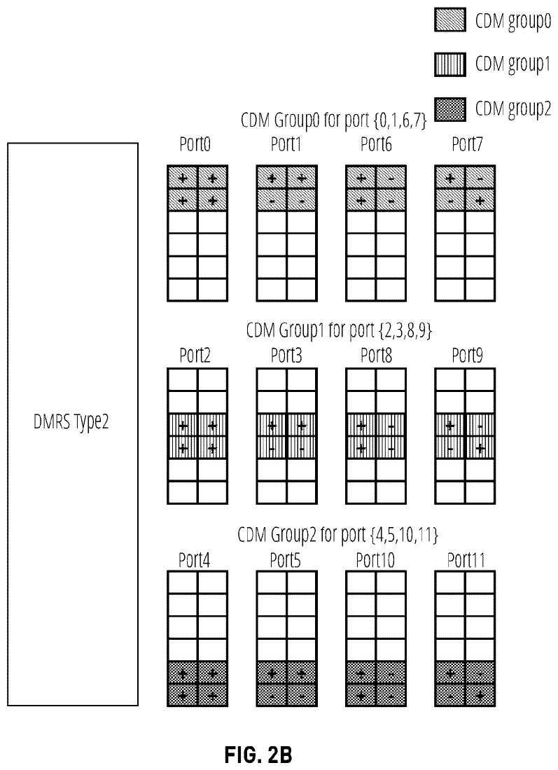

FIG. 3 is a flowchart of a method 300 for a base station in a wireless network to configure multi-user multiple-input multiple-output (MU-MIMO) scheduling according to one embodiment. In block 302, the method 300 includes determining a first demodulation reference signal (DMRS) pattern configured to support a first number of DMRS ports for a DMRS configuration type and a DMRS symbol length. In block 304, the method 300 includes determining a second DMRS pattern configured to support a second number of DMRS ports for the DMRS configuration type and the DMRS symbol length. The second number of DMRS ports is greater than the first number of DMRS ports for the DMRS configuration type and the DMRS symbol length. In block 306, when a first user equipment (UE) is configured to use the second DMRS pattern, the method 300 includes determining whether to apply one or more MU-MIMO scheduling restrictions for co-scheduling the first UE with one or more second UE. In block 308, the method 300 includes performing the MU-MIMO scheduling for the first UE and the one or more second UE.

In certain embodiments of the method 300, when the DMRS configuration type comprises DMRS Type 1, the one or more MU-MIMO scheduling restrictions comprise at least one of: the first UE cannot be co-scheduled with the one or more second UE (when the one or more second UE is configured to use the second DMRS pattern in a same code division multiplexing (CDM) group used for the first UE configured with the second DMRS pattern); and/or the first UE cannot be co-scheduled with the one or more second UE (when the one or more second UE is configured to use the first DMRS pattern in the same CDM group used for the first UE configured with the second DMRS pattern).

In certain embodiments of the method 300, when the DMRS configuration type comprises DMRS Type 1 or DMRS Type 2, and when the base station configures: one code division multiplexing (CDM) group without data; the DMRS symbol length as one symbol; and a DMRS port 0 and a DMRS port 1 (DMRS port {0, 1}), the one or more MU-MIMO scheduling restrictions comprise at least one of: the first UE is not expected to be co-scheduled with the one or more second UE (when a total number of CDM groups is increased to support an increased number of DMRS ports); and/or the first UE can be co-scheduled with the one or more second UE (when the total number of CDM groups is not increased to support the increased number of DMRS ports). When the first UE can be co-scheduled with the one or more second UE, in one embodiment, the one or more second UE is configured to use the second DMRS pattern. When the first UE can be co-scheduled with the one or more second UE, in another embodiment, the one or more second UE can be configured to use either the first DMRS pattern or the second DMRS pattern.

In certain embodiments of the method 300, when the DMRS configuration type comprises DMRS Type 1 or DMRS Type 2, and wherein when the base station configures: two code division multiplexing (CDM) groups without data; the DMRS symbol length as one symbol; and a DMRS port 0, a DMRS port 1, a DMRS port 2, and a DMRS port 3 (DMRS port {0, 1, 2, 3}), the one or more MU-MIMO scheduling restrictions comprise at least one of: the first UE is not expected to be co-scheduled with the one or more second UE (when a total number of CDM groups is increased to support an increased number of DMRS ports); and/or the first UE can be co-scheduled with the one or more second UE (when the total number of CDM groups is not increased to support the increased number of DMRS ports). When the first UE can be co-scheduled with the one or more second UE, in one embodiment, the one or more second UE is configured to use the second DMRS pattern. When the first UE can be co-scheduled with the one or more second UE, in another embodiment, the one or more second UE can be configured to use either the first DMRS pattern or the second DMRS pattern.

In certain embodiments of the method 300, when the DMRS configuration type comprises DMRS Type 1 or DMRS Type 2, and wherein when the base station configures: two code division multiplexing (CDM) groups without data; the DMRS symbol length as one symbol; and a DMRS port 0 and a DMRS port 2 (DMRS port {0, 2}), the one or more MU-MIMO scheduling restrictions comprise: the first UE is not expected to be co-scheduled with the one or more second UE; or the first UE can be co-scheduled with the one or more second UE. When the first UE is not expected to be co-scheduled with the one or more second UE, in one embodiment, the method further comprises enabling the MU-MIMO co-scheduling for the first UE by the DMRS port 0 and a DMRS port 1 (DMRS port {0, 1}). When the first UE can be co-scheduled with the one or more second UE, in one embodiment, the one or more second UE is configured to use the second DMRS pattern. When the first UE can be co-scheduled with the one or more second UE, in another embodiment, the one or more second UE can be configured to use either the first DMRS pattern or the second DMRS pattern.

In certain embodiments of the method 300, when the DMRS configuration type comprises DMRS Type 1, and wherein when the base station configures: two code division multiplexing (CDM) groups without data; the DMRS symbol length as two symbols; and a DMRS port 0, a DMRS port 2, a DMRS port 4, and a DMRS port 6 (DMRS port {0, 2, 4, 6}), the one or more MU-MIMO scheduling restrictions comprise: the first UE is not expected to be co-scheduled with the one or more second UE; or the first UE can be co-scheduled with the one or more second UE. When the first UE is not expected to be co-scheduled with the one or more second UE, in one embodiment, the method further comprises enabling the MU-MIMO co-scheduling for the first UE by the DMRS port 0, a DMRS port 1, the DMRS port 4, and a DMRS port 5 (DMRS port {0, 1, 4, 5}). When the first UE can be co-scheduled with the one or more second UE, in one embodiment, the one or more second UE is configured to use the second DMRS pattern. When the first UE can be co-scheduled with the one or more second UE, in another embodiment, the one or more second UE can be configured to use either the first DMRS pattern or the second DMRS pattern.

In certain embodiments of the method 300, when the DMRS configuration type comprises DMRS Type 1, and wherein when the base station configures: two code division multiplexing (CDM) groups without data; the DMRS symbol length as one symbol; and a DMRS port 0, a DMRS port 1, and a DMRS port 2 (DMRS port {0, 1, 2}), the one or more MU-MIMO scheduling restrictions comprise: the first UE is not expected to be co-scheduled with the one or more second UE; or the first UE can be co-scheduled with the one or more second UE. When the first UE is not expected to be co-scheduled with the one or more second UE, in one embodiment, the method further comprises changing the DMRS configuration type from DMRS Type 1 to DMRS Type 2 to co-schedule the first UE with the one or more second UE. When the first UE can be co-scheduled with the one or more second UE, in one embodiment, the one or more second UE is configured to use the second DMRS pattern. When the first UE can be co-scheduled with the one or more second UE, in another embodiment, the one or more second UE can be configured to use either the first DMRS pattern or the second DMRS pattern.

In certain embodiments of the method 300, when the DMRS configuration type comprises DMRS Type 1 or DMRS Type 2, and wherein when the base station configures a DMRS port 0, a DMRS port 2, and a DMRS port 3 (DMRS port {0, 2, 3}), the one or more MU-MIMO scheduling restrictions comprise the first UE is not expected to be co-scheduled with the one or more second UE.

### Dynamic DMRS Mode Indication

In certain embodiments, a wireless communication system (e.g., an NR system) may use two DMRS modes. A first DMRS mode (e.g., a legacy DMRS mode) supports up to 12 DMRS ports. A second DMRS mode (e.g., an enhanced DMRS mode) supports up to 24 DMRS ports. Certain such wireless communication systems may configure the DMRS modes using radio resource configuration (RRC) signaling.

In DL, for example, a bandwidth part (BWP) downlink dedicated (BWP-Downlink Dedicated) information element (IE) may include a PDSCH configuration (PDSCH-Config) IE, which includes a DMRS downlink configuration (DRMS-DownlinkConfig) IE with DMRS configuration information to configure a DMRS mode. In UL, for example, a BWP uplink dedicated (BWP-UplinkDedicated) IE may include a physical uplink shared channel (PUSCH) configuration (PUSCH-Config) IE, which includes a DMRS uplink configuration (DMRS-UplinkConfig) IE with DMRS configuration information to configure a DMRS mode. For UL or DL, the DMRS configuration information may include at least one of a DMRS configuration type (e.g., indicated by parameter dmrs-Type ENUMERATED {type2}), a maximum number of DMRS symbols per location (e.g., indicated by parameter maxLength ENUMERATED {len2}), a DMRS starting position, and a DMRS additional position (e.g., indicated by parameter dmrs-AdditionalPosition ENUMERATED {pos0, pos1, pos3}).

In certain embodiments, a wireless network dynamically indicates the DMRS mode to a UE. For example, the wireless network may indicate the DMRS mode to the UE via a media access control (MAC) control element (CE) or via DCI.

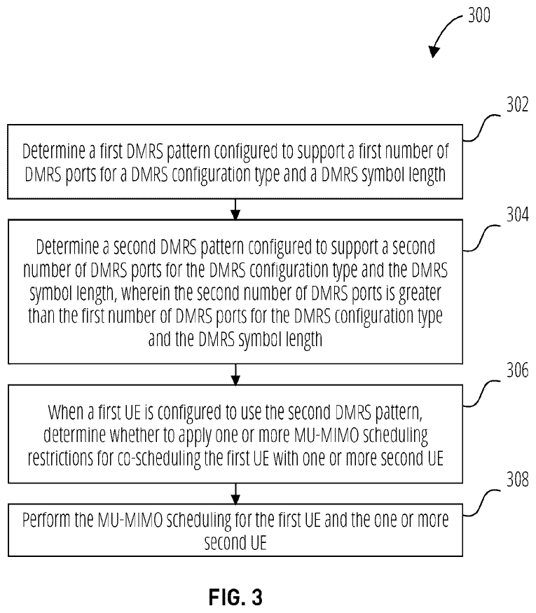

FIG. 4 illustrates an example data structure 400 of a MAC CE for indicating a DMRS mode to a UE according to one embodiment. In this example, the data structure 400 is eight bits wide (labeled bits 0, 1, 2, 3, 4, 5, 6, 7). A “D/U” parameter comprises a single bit to indicate whether the MAC CE is for DL or UL. A “Serving Cell ID” parameter comprising five bits indicates the identifier (ID) of the corresponding serving cell. A “BWP ID” parameter comprising two bits identifies the corresponding BWP. An “A/D” parameter comprising a single bit indicates a legacy or enhanced DMRS mode. As shown, this example also include an “R” parameter of seven reserved bits.

In certain embodiments, the MAC CE is also configured for one or more of modifying the DMRS mode on multiple component carriers (CCs) simultaneously, modifying the DMRS mode on multiple BWPs simultaneously, and/or modifying the DMRS mode on both DL and UL simultaneously. In addition, or in other embodiments, the MAC CE may be configured to modify the DMRS configuration information including, for example, modifying the DMRS configuration type (i.e., Type 1 or Type 2), modifying the DMRS additional location (i.e., “pos 0”, “pos1”, “pos2”, “pos3”), and/or modifying the maximum number of DMRS symbols per location (i.e., 1 or 2).

As mentioned above, in certain embodiments, the wireless network may indicate the DMRS mode to the UE via DCI. In one embodiment, for example, the DCI includes a single-bit field to indicate whether the wireless network indicates legacy or enhanced DMRS mode.

Another embodiment uses the most significant bit (MSB), or the least significant bit (LSB), of the antenna port(s) field in the DCI to indicate the DMRS mode to the UE. For example, an RRC message may first configure the DMRS mode to be “legacy” DMRS mode or “enhanced” DMRS mode or “dynamic” DMRS mode. The bitwidth of the antenna port(s) field in the DCI depends on the RRC configured DMRS mode. When the RRC message configures a dynamic DMRS mode, the MSB (or LSB) of the antenna port(s) field in the DCI dynamically indicates whether legacy or enhanced DMRS mode is indicated.

In another embodiment for dynamically indicating the DMRS mode to the UE via DCI, a column may be added to an antenna port table. For example, a column may be added to Tables 7.3.1.2.2-1/1A/2/2A/3/3A/4/4A in 3GPP TS 38.213. The additional column corresponds to whether legacy or enhanced DMRS mode is indicated. In other words, when the antenna port(s) field in DCI indicates to a particular row in the new antenna port table with an additional column corresponding to the DMRS mode, the UE determines whether the enhanced DMRS mode is indicated by the wireless network based on the row indicated in the antenna port(s) field in DCI.

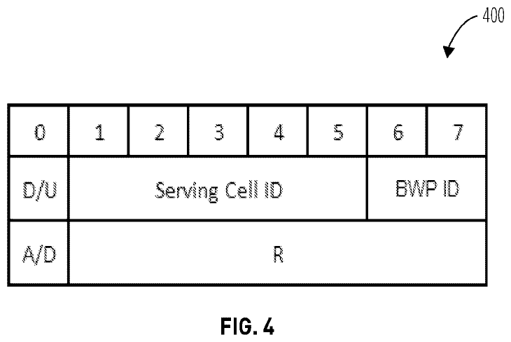

FIG. 5 is a flowchart of a method 500 for a user equipment (UE) in a wireless network according to one embodiment. In block 502, the method 500 includes receiving, at the UE from a base station, a radio resource control (RRC) message comprising demodulation reference signal (DMRS) configuration information including at least one of a DMRS configuration type, a maximum number of DMRS symbols per location, a DMRS starting position, and a DMRS additional position. In block 504, the method 500 includes receiving, at the UE from the base station, a dynamic DMRS mode indication for the UE to select one of a first DMRS mode that supports up to 12 DMRS ports and a second DMRS mode that supports up to 24 DMRS ports. In block 506, the method 500 includes processing, at the UE, a DMRS based on a selection of the first DMRS mode or the second DMRS mode indicated by the dynamic DMRS mode indication from the base station.

In certain embodiments of the method 500, receiving the dynamic DMRS mode indication comprises receiving, at the UE from the base station, a medium access control (MAC) control element (CE) including a single bit to indicate either the first DMRS mode or the second DMRS mode. The MAC CE may further indicate at least one of: whether the dynamic mode indication from the base station corresponds to an uplink DMRS configuration or a downlink DMRS configuration; a serving cell identifier (ID); and a bandwidth part (BWP) ID. In addition, or in other embodiments, the MAC CE is configured to modify one or more of: a DMRS mode on multiple component carriers (CCs) simultaneously, a DMRS mode on multiple bandwidth parts (BWPs) simultaneously, and/or a DMRS mode of both an uplink DMRS configuration and a downlink DMRS configuration simultaneously. In certain embodiments, the MAC CE is configured to modify the DMRS configuration information.

In certain embodiments of the method 500, receiving the dynamic DMRS mode indication comprises receiving, at the UE from the base station, downlink control information (DCI) indicating either the first DMRS mode or the second DMRS mode. The DCI may comprise a single bit field to indicate either the first DMRS mode or the second DMRS mode.

In certain embodiments, the method 500 further comprises determining either the first DMRS mode or the second DMRS mode from a most significant bit (MSB) or a least significant bit (LSB) of an antenna ports field in the DCI. The RRC message may initialize a DMRS mode to one of the first DMRS mode, the second DMRS mode, or a dynamic DMRS mode. A bitwidth of the antenna ports field in the DCI corresponds to the DMRS mode initialized by the RRC message. When the DMRS mode is initialized by the RRC to the dynamic DMRS mode, the MSB or the LSB of the antenna ports field indicates reselection to either the first DMRS mode or the second DMRS mode.

In certain embodiments of the method 500, the DCI indicates a column in an antenna port table that corresponds to either the first DMRS mode or the second DMRS mode.

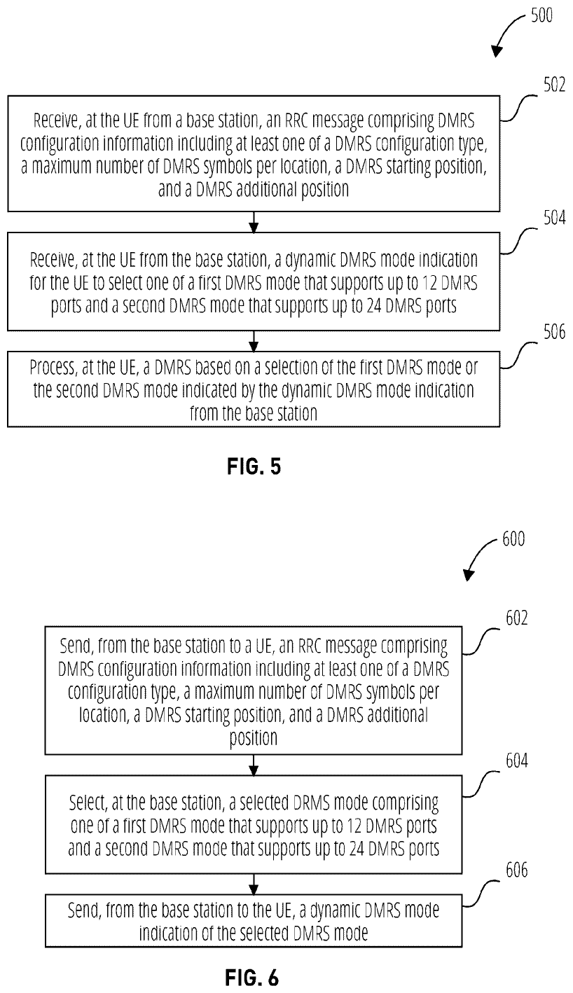

FIG. 6 is a method 600 for a base station in a wireless network according to one embodiment. In block 602, the method 600 includes sending, from the base station to a user equipment (UE), a radio resource control (RRC) message comprising demodulation reference signal (DMRS) configuration information including at least one of a DMRS configuration type, a maximum number of DMRS symbols per location, a DMRS starting position, and a DMRS additional position. In block 604, the method 600 includes selecting, at the base station, a selected DRMS mode comprising one of a first DMRS mode that supports up to 12 DMRS ports and a second DMRS mode that supports up to 24 DMRS ports. In block 606, the method 600 includes sending, from the base station to the UE, a dynamic DMRS mode indication of the selected DMRS mode.

In certain embodiments of the method 600, sending the dynamic DMRS mode indication comprises sending, from the base station to the UE, a medium access control (MAC) control element (CE) including a single bit to indicate either the first DMRS mode or the second DMRS mode. The MAC CE may further indicate at least one of: whether the selected DMRS mode corresponds to an uplink DMRS configuration or a downlink DMRS configuration; a serving cell identifier (ID); and/or a bandwidth part (BWP) ID. The MAC CE may be configured to modify one or more of the selected DMRS mode on multiple component carriers (CCs) simultaneously, the selected DMRS mode on multiple bandwidth parts (BWPs) simultaneously, and/or the selected DMRS mode of both an uplink DMRS configuration and a downlink DMRS configuration simultaneously. In certain embodiments, the MAC CE is configured to modify the DMRS configuration information.

In certain embodiments of the method 600, sending the dynamic DMRS mode indication comprises sending, from the base station to the UE, downlink control information (DCI) indicating either the first DMRS mode or the second DMRS mode. The DCI may comprise a single bit field to indicate that the selected DMRS mode is either the first DMRS mode or the second DMRS mode.

Certain embodiments of the method 600 further comprise configuring a most significant bit (MSB) or a least significant bit (LSB) of an antenna ports field in the DCI to indicate either the first DMRS mode or the second DMRS mode. The RRC message may initialize the UE to one of the first DMRS mode, the second DMRS mode, or a dynamic DMRS mode. A bitwidth of the antenna ports field in the DCI corresponds to the DMRS mode initialized by the RRC message. When the DMRS mode is initialized by the RRC to the dynamic DMRS mode, the MSB or the LSB of the antenna ports field indicates reselection to either the first DMRS mode or the second DMRS mode.

In certain embodiments of the method 600, the DCI indicates a column in an antenna port table that corresponds to either the first DMRS mode or the second DMRS mode.

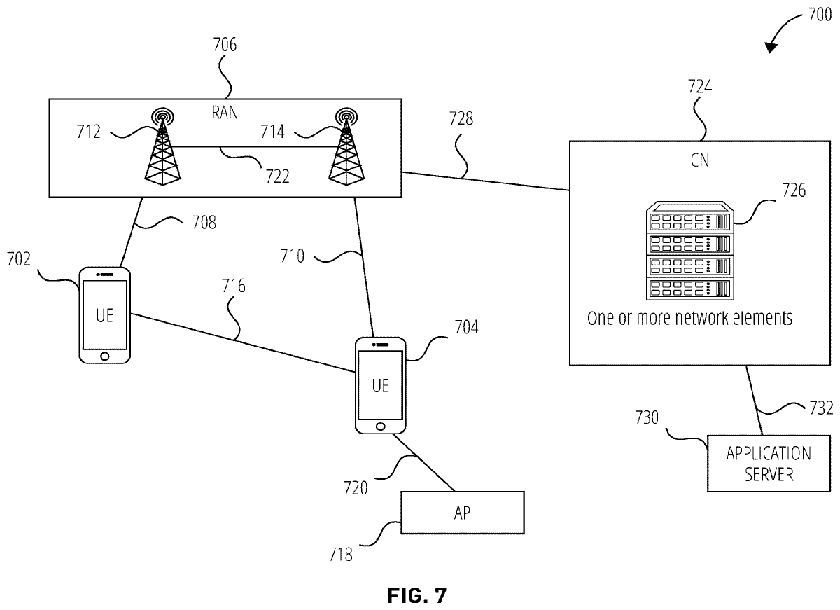

FIG. 7 illustrates an example architecture of a wireless communication system 700, according to embodiments disclosed herein. The following description is provided for an example wireless communication system 700 that operates in conjunction with the LTE system standards and/or 5G or NR system standards as provided by 3GPP technical specifications.

As shown by FIG. 7, the wireless communication system 700 includes UE 702 and UE 704 (although any number of UEs may be used). In this example, the UE 702 and the UE 704 are illustrated as smartphones (e.g., handheld touchscreen mobile computing devices connectable to one or more cellular networks), but may also comprise any mobile or non-mobile computing device configured for wireless communication.

The UE 702 and UE 704 may be configured to communicatively couple with a RAN 706. In embodiments, the RAN 706 may be NG-RAN, E-UTRAN, etc. The UE 702 and UE 704 utilize connections (or channels) (shown as connection 708 and connection 710, respectively) with the RAN 706, each of which comprises a physical communications interface. The RAN 706 can include one or more base stations (such as base station 712 and base station 714) that enable the connection 708 and connection 710.

In this example, the connection 708 and connection 710 are air interfaces to enable such communicative coupling, and may be consistent with RAT(s) used by the RAN 706, such as, for example, an LTE and/or NR.

In some embodiments, the UE 702 and UE 704 may also directly exchange communication data via a sidelink interface 716. The UE 704 is shown to be configured to access an access point (shown as AP 718) via connection 720. By way of example, the connection 720 can comprise a local wireless connection, such as a connection consistent with any IEEE 802.11 protocol, wherein the AP 718 may comprise a Wi-Fi® router. In this example, the AP 718 may be connected to another network (for example, the Internet) without going through a CN 724.

In embodiments, the UE 702 and UE 704 can be configured to communicate using orthogonal frequency division multiplexing (OFDM) communication signals with each other or with the base station 712 and/or the base station 714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 712 or base station 714 may be implemented as one or more software entities running on server computers as part of a virtual network. In addition, or in other embodiments, the base station 712 or base station 714 may be configured to communicate with one another via interface 722. In embodiments where the wireless communication system 700 is an LTE system (e.g., when the CN 724 is an EPC), the interface 722 may be an X2 interface. The X2 interface may be defined between two or more base stations (e.g., two or more eNBs and the like) that connect to an EPC, and/or between two eNBs connecting to the EPC. In embodiments where the wireless communication system 700 is an NR system (e.g., when CN 724 is a 5GC), the interface 722 may be an Xn interface. The Xn interface is defined between two or more base stations (e.g., two or more gNBs and the like) that connect to 5GC, between a base station 712 (e.g., a gNB) connecting to 5GC and an eNB, and/or between two eNBs connecting to 5GC (e.g., CN 724).

The RAN 706 is shown to be communicatively coupled to the CN 724. The CN 724 may comprise one or more network elements 726, which are configured to offer various data and telecommunications services to customers/subscribers (e.g., users of UE 702 and UE 704) who are connected to the CN 724 via the RAN 706. The components of the CN 724 may be implemented in one physical device or separate physical devices including components to read and execute instructions from a machine-readable or computer-readable medium (e.g., a non-transitory machine-readable storage medium).

In embodiments, the CN 724 may be an EPC, and the RAN 706 may be connected with the CN 724 via an S1 interface 728. In embodiments, the S1 interface 728 may be split into two parts, an S1 user plane (S1-U) interface, which carries traffic data between the base station 712 or base station 714 and a serving gateway (S-GW), and the SI-MME interface, which is a signaling interface between the base station 712 or base station 714 and mobility management entities (MMEs).

In embodiments, the CN 724 may be a 5GC, and the RAN 706 may be connected with the CN 724 via an NG interface 728. In embodiments, the NG interface 728 may be split into two parts, an NG user plane (NG-U) interface, which carries traffic data between the base station 712 or base station 714 and a user plane function (UPF), and the S1 control plane (NG-C) interface, which is a signaling interface between the base station 712 or base station 714 and access and mobility management functions (AMFs).

Generally, an application server 730 may be an element offering applications that use internet protocol (IP) bearer resources with the CN 724 (e.g., packet switched data services). The application server 730 can also be configured to support one or more communication services (e.g., VoIP sessions, group communication sessions, etc.) for the UE 702 and UE 704 via the CN 724. The application server 730 may communicate with the CN 724 through an IP communications interface 732.

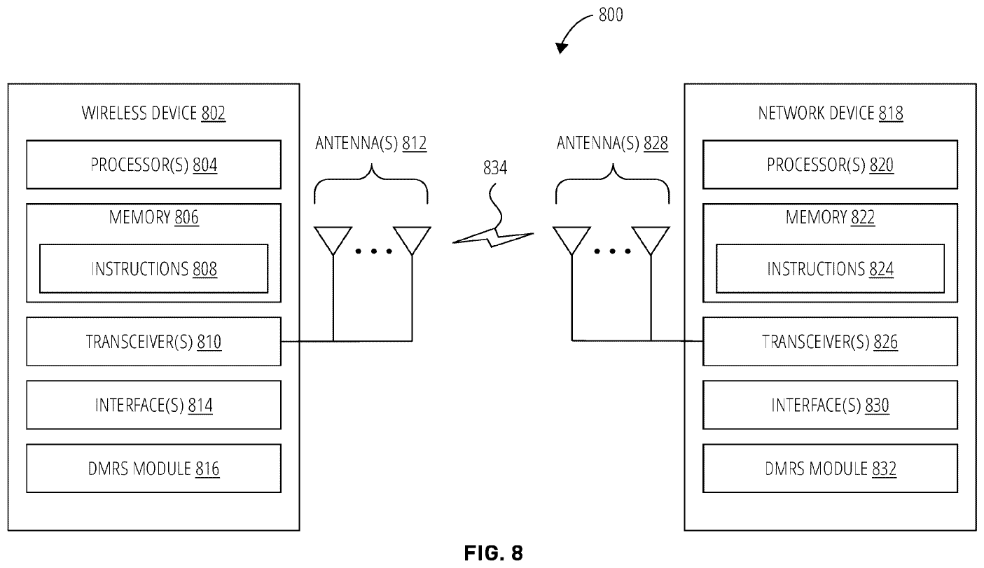

FIG. 8 illustrates a system 800 for performing signaling 834 between a wireless device 802 and a network device 818, according to embodiments disclosed herein. The system 800 may be a portion of a wireless communications system as herein described. The wireless device 802 may be, for example, a UE of a wireless communication system. The network device 818 may be, for example, a base station (e.g., an eNB or a gNB) of a wireless communication system.

The wireless device 802 may include one or more processor(s) 804. The processor(s) 804 may execute instructions such that various operations of the wireless device 802 are performed, as described herein. The processor(s) 804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 802 may include a memory 806. The memory 806 may be a non-transitory computer-readable storage medium that stores instructions 808 (which may include, for example, the instructions being executed by the processor(s) 804). The instructions 808 may also be referred to as program code or a computer program. The memory 806 may also store data used by, and results computed by, the processor(s) 804.

The wireless device 802 may include one or more transceiver(s) 810 that may include radio frequency (RF) transmitter and/or receiver circuitry that use the antenna(s) 812 of the wireless device 802 to facilitate signaling (e.g., the signaling 834) to and/or from the wireless device 802 with other devices (e.g., the network device 818) according to corresponding RATs.

The wireless device 802 may include one or more antenna(s) 812 (e.g., one, two, four, or more). For embodiments with multiple antenna(s) 812, the wireless device 802 may leverage the spatial diversity of such multiple antenna(s) 812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 802 may be accomplished according to precoding (or digital beamforming) that is applied at the wireless device 802 that multiplexes the data streams across the antenna(s) 812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 802 may implement analog beamforming techniques, whereby phases of the signals sent by the antenna(s) 812 are relatively adjusted such that the (joint) transmission of the antenna(s) 812 can be directed (this is sometimes referred to as beam steering).

The wireless device 802 may include one or more interface(s) 814. The interface(s) 814 may be used to provide input to or output from the wireless device 802. For example, a wireless device 802 that is a UE may include interface(s) 814 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 810/antenna(s) 812 already described) that allow for communication between the UE and other devices and may operate according to known protocols (e.g., Wi-Fi®, Bluetooth®, and the like).

The wireless device 802 may include a DMRS module 816. The DMRS module 816 may be implemented via hardware, software, or combinations thereof. For example, the DMRS module 816 may be implemented as a processor, circuit, and/or instructions 808 stored in the memory 806 and executed by the processor(s) 804. In some examples, the DMRS module 816 may be integrated within the processor(s) 804 and/or the transceiver(s) 810. For example, the DMRS module 816 may be implemented by a combination of software components (e.g., executed by a DSP or a general processor) and hardware components (e.g., logic gates and circuitry) within the processor(s) 804 or the transceiver(s) 810.

The DMRS module 816 may be used for various aspects of the present disclosure, for example, aspects of FIG. 5.

The network device 818 may include one or more processor(s) 820. The processor(s) 820 may execute instructions such that various operations of the network device 818 are performed, as described herein. The processor(s) 820 may include one or more baseband processors implemented using, for example, a CPU, a DSP, an ASIC, a controller, an FPGA device, another hardware device, a firmware device, or any combination thereof configured to perform the operations described herein.

The network device 818 may include a memory 822. The memory 822 may be a non-transitory computer-readable storage medium that stores instructions 824 (which may include, for example, the instructions being executed by the processor(s) 820). The instructions 824 may also be referred to as program code or a computer program. The memory 822 may also store data used by, and results computed by, the processor(s) 820.

The network device 818 may include one or more transceiver(s) 826 that may include RF transmitter and/or receiver circuitry that use the antenna(s) 828 of the network device 818 to facilitate signaling (e.g., the signaling 834) to and/or from the network device 818 with other devices (e.g., the wireless device 802) according to corresponding RATs.

The network device 818 may include one or more antenna(s) 828 (e.g., one, two, four, or more). In embodiments having multiple antenna(s) 828, the network device 818 may perform MIMO, digital beamforming, analog beamforming, beam steering, etc., as has been described.

The network device 818 may include one or more interface(s) 830. The interface(s) 830 may be used to provide input to or output from the network device 818. For example, a network device 818 that is a base station may include interface(s) 830 made up of transmitters, receivers, and other circuitry (e.g., other than the transceiver(s) 826/antenna(s) 828 already described) that enables the base station to communicate with other equipment in a core network, and/or that enables the base station to communicate with external networks, computers, databases, and the like for purposes of operations, administration, and maintenance of the base station or other equipment operably connected thereto.

The network device 818 may include a DMRS module 832. The DMRS module 832 may be implemented via hardware, software, or combinations thereof. For example, the DMRS module 832 may be implemented as a processor, circuit, and/or instructions 824 stored in the memory 822 and executed by the processor(s) 820. In some examples, the DMRS module 832 may be integrated within the processor(s) 820 and/or the transceiver(s) 826. For example, the DMRS module 832 may be implemented by a combination of software components (e.g., executed by a DSP or a general processor) and hardware components (e.g., logic gates and circuitry) within the processor(s) 820 or the transceiver(s) 826.

The DMRS module 832 may be used for various aspects of the present disclosure, for example, aspects of FIG. 3 and FIG. 6.

Embodiments contemplated herein include an apparatus comprising means to perform one or more elements of the method 500. This apparatus may be, for example, an apparatus of a UE (such as a wireless device 802 that is a UE, as described herein).

Embodiments contemplated herein include one or more non-transitory computer-readable media comprising instructions to cause an electronic device, upon execution of the instructions by one or more processors of the electronic device, to perform one or more elements of the method 500. This non-transitory computer-readable media may be, for example, a memory of a UE (such as a memory 806 of a wireless device 802 that is a UE, as described herein).

Embodiments contemplated herein include an apparatus comprising logic, modules, or circuitry to perform one or more elements of the method 500. This apparatus may be, for example, an apparatus of a UE (such as a wireless device 802 that is a UE, as described herein).

Embodiments contemplated herein include an apparatus comprising: one or more processors and one or more computer-readable media comprising instructions that, when executed by the one or more processors, cause the one or more processors to perform one or more elements of the method 500. This apparatus may be, for example, an apparatus of a UE (such as a wireless device 802 that is a UE, as described herein).

Embodiments contemplated herein include a signal as described in or related to one or more elements of the method 500.

Embodiments contemplated herein include a computer program or computer program product comprising instructions, wherein execution of the program by a processor is to cause the processor to carry out one or more elements of the method 500. The processor may be a processor of a UE (such as a processor(s) 804 of a wireless device 802 that is a UE, as described herein). These instructions may be, for example, located in the processor and/or on a memory of the UE (such as a memory 806 of a wireless device 802 that is a UE, as described herein).

Embodiments contemplated herein include an apparatus comprising means to perform one or more elements of the method 300 and/or the method 600. This apparatus may be, for example, an apparatus of a base station (such as a network device 818 that is a base station, as described herein).

Embodiments contemplated herein include one or more non-transitory computer-readable media comprising instructions to cause an electronic device, upon execution of the instructions by one or more processors of the electronic device, to perform one or more elements of the method 300 and/or the method 600. This non-transitory computer-readable media may be, for example, a memory of a base station (such as a memory 822 of a network device 818 that is a base station, as described herein).

Embodiments contemplated herein include an apparatus comprising logic, modules, or circuitry to perform one or more elements of the method 300 and/or the method 600. This apparatus may be, for example, an apparatus of a base station (such as a network device 818 that is a base station, as described herein).

Embodiments contemplated herein include an apparatus comprising: one or more processors and one or more computer-readable media comprising instructions that, when executed by the one or more processors, cause the one or more processors to perform one or more elements of the method 300 and/or the method 600. This apparatus may be, for example, an apparatus of a base station (such as a network device 818 that is a base station, as described herein).

Embodiments contemplated herein include a signal as described in or related to one or more elements of the method 300 and/or the method 600.

Embodiments contemplated herein include a computer program or computer program product comprising instructions, wherein execution of the program by a processing element is to cause the processing element to carry out one or more elements of the method 300 and/or the method 600. The processor may be a processor of a base station (such as a processor(s) 820 of a network device 818 that is a base station, as described herein). These instructions may be, for example, located in the processor and/or on a memory of the base station (such as a memory 822 of a network device 818 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc, as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc, of one embodiment can be used in another embodiment. The parameters, attributes, aspects, etc. are merely described in one or more embodiments for clarity, and it is recognized that the parameters, attributes, aspects, etc, can be combined with or substituted for parameters, attributes, aspects, etc, of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE) for communication in a wireless network, the UE comprising:
a transceiver; and
one or more processors in communication with the transceiver, the one or more processors to:
process a radio resource control (RRC) message from a base station comprising demodulation reference signal (DMRS) configuration information including at least one of a DMRS configuration type, a maximum number of DMRS symbols per location, a DMRS starting position, and a DMRS additional position;
process a dynamic DMRS mode indication from the base station for the UE to select one of a first DMRS mode that supports up to 12 DMRS ports and a second DMRS mode that supports up to 24 DMRS ports; and
process a DMRS based on a selection of the first DMRS mode or the second DMRS mode indicated by the dynamic DMRS mode indication from the base station.

2. The UE of claim 1, wherein to process the dynamic DMRS mode indication comprises receiving, at the UE from the base station, a medium access control (MAC) control element (CE) including a single bit to indicate either the first DMRS mode or the second DMRS mode.

3. The UE of claim 2, wherein the MAC CE further indicates at least one of:
whether the dynamic mode indication from the base station corresponds to an uplink DMRS configuration or a downlink DMRS configuration;
a serving cell identifier (ID); and
a bandwidth part (BWP) ID.

4. The UE of claim 2, wherein the MAC CE is configured to modify a DMRS mode on multiple component carriers (CCs) simultaneously.

5. The UE of claim 2, wherein the MAC CE is configured to modify a DMRS mode on multiple bandwidth parts (BWPs) simultaneously.

6. The UE of claim 2, wherein the MAC CE is configured to modify a DMRS mode of both an uplink DMRS configuration or a downlink DMRS configuration simultaneously.

7. The UE of claim 2, wherein the MAC CE is configured to modify the DMRS configuration information.

8. The UE of claim 1, wherein to process the dynamic DMRS mode indication comprises receiving, at the UE from the base station, downlink control information (DCI) indicating either the first DMRS mode or the second DMRS mode.

9. The UE of claim 8, wherein the DCI comprises a single bit field to indicate either the first DMRS mode or the second DMRS mode.

10. The UE of claim 8, wherein the one or more processors are further to determine either the first DMRS mode or the second DMRS mode from a most significant bit (MSB) or a least significant bit (LSB) of an antenna ports field in the DCI.

11. The UE of claim 10, wherein the RRC message initializes a DMRS mode to one of the first DMRS mode, the second DMRS mode, or a dynamic DMRS mode,
wherein a bitwidth of the antenna ports field in the DCI corresponds to the DMRS mode initialized by the RRC message, and
wherein when the DMRS mode is initialized by the RRC to the dynamic DMRS mode, the MSB or the LSB of the antenna ports field indicates reselection to either the first DMRS mode or the second DMRS mode.

12. The UE of claim 8, wherein the DCI indicates a column in an antenna port table that corresponds to either the first DMRS mode or the second DMRS mode.

13. A base station for communication in a wireless network, the base station comprising:
a memory to store demodulation reference signal (DMRS) configuration information; and
one or more processors in communication with the memory, the one or more processors to:
generate a radio resource control (RRC) message, to send from the base station to the UE, the RRC message comprising the DMRS configuration information including at least one of a DMRS configuration type, a maximum number of DMRS symbols per location, a DMRS starting position, and a DMRS additional position;
determine a selected DRMS mode comprising one of a first DMRS mode that supports up to 12 DMRS ports and a second DMRS mode that supports up to 24 DMRS ports; and
generate a dynamic DMRS mode indication, to send from the base station to the UE, of the selected DMRS mode.

14. The base station of claim 13, wherein to generate the dynamic DMRS mode indication comprises generating a medium access control (MAC) control element (CE) including a single bit to indicate either the first DMRS mode or the second DMRS mode.

15. The base station of claim 14, wherein the MAC CE further indicates at least one of:
whether the selected DMRS mode corresponds to an uplink DMRS configuration or a downlink DMRS configuration;
a serving cell identifier (ID); and
a bandwidth part (BWP) ID.

16. The base station of claim 14, wherein the MAC CE is configured to modify the selected DMRS mode on multiple component carriers (CCs) simultaneously.

17. The base station of claim 14, wherein the MAC CE is configured to modify the selected DMRS mode on multiple bandwidth parts (BWPs) simultaneously.

18. The base station of claim 14, wherein the MAC CE is configured to modify the selected DMRS mode of both an uplink DMRS configuration or a downlink DMRS configuration simultaneously.

19. The base station of claim 14, wherein the MAC CE is configured to modify the DMRS configuration information.

20. The base station of claim 13, wherein to generate the dynamic DMRS mode indication comprises generating downlink control information (DCI) indicating either the first DMRS mode or the second DMRS mode.

21-50. (canceled)
